(19) United States
(12) Patent Application Publication
(10) Pub. No.: US 2026/0157555 A1
(43) Pub. Date: Jun. 11, 2026

(54) FOOD PREPARATION APPLIANCE

(71) Applicant: SANTOS, VAULX-EN-VELIN (FR)

(72) Inventors: Nicolas FOUQUET, VAULX-EN-VELIN (FR); Cédric GELIN, LYON (FR)

(21) Appl. No.: 19/416,285

(22) Filed: Dec. 11, 2025

(30) Foreign Application Priority Data
Dec. 11, 2024 (FR) FR2413892

(51) Int. Cl. A47J 19/02; A47J 43/08

(52) U.S. Cl. CPC A47J 19/02; A47J 43/085

(57) ABSTRACT

A culinary preparation appliance including a base, a tool, a cover, and a locking system of the cover including an actuation device, a lever, driven in rotation relative to the base by the actuation device, and a hook, set in motion by the lever. The hook includes a lower end, attached to the first lever, an upper end, and an elongated central portion extending through an opening in the base. The opening in the base guides the central portion, so that the first hook is able to slide relative to the base along its central portion and, jointly, pivot relative to the base. The appliance is thus operable, by a rotation of the lever, between a locked configuration, wherein the upper end of the hook prevents removal of the cover, and an unlocked configuration wherein the cover can be removed.

### INCORPORATION BY REFERENCE TO ANY PRIORITY APPLICATIONS

Any and all applications for which a foreign or domestic priority claim is identified in the Application Data Sheet as filed with the present application are hereby incorporated by reference.

### FIELD

The present disclosure relates to a food preparation appliance, notably a juicer.

### BACKGROUND

A food preparation appliance ensures the preparation of foods admitted into it, notably by pressing, cutting, grating, or slicing. It finds its application in all types of foods, whether fruits or vegetables, fish, or even meat. Such a food preparation appliance is commonly used in the hospitality professions, or in collective catering, and also in private use. By means of non-limiting examples, it may include a juicer for fruits and vegetables, a blender, a citrus press, a cheese grater, a vegetable cutter, or even a multifunction robot.

In the case of a juicer, it includes a fixed base, on which a rotary tool, generally a rotary basket, is removably mounted, driven by an electric motor. This rotary tool comprises a bottom, forming a grater, as well as side walls extending from this bottom, which constitute a sieve.

Furthermore, a removable lid is provided, wherein an introduction opening is arranged, allowing the introduction of food, particularly fruits and vegetables. The lid covers the rotary basket and notably the grater, thus protecting the user from any contact with the grater. In operation, the food is kept in contact with the grater rotating at high speed, by means of a pusher manipulated by the user and passing through the introduction opening.

Under these conditions, the food is shredded near the grater. The sieve then allows the juice to flow while retaining the solid parts of the food. These foods are then evacuated, under the effect of centrifugal force, towards the upper part of the basket, then collected in a reservoir or a bin. Furthermore, the liquid juice having passed through the walls of the sieve is collected in a juice tank.

Such a food preparation appliance includes a locking system to ensure reliable braking and stopping of the rotary tool when the user seeks to remove the removable lid. Thus, access to the rotary tool when it is in rotation is prevented, ensuring user safety.

FR-A-2 830 423 is known, which describes a food preparation appliance of this type, wherein the locking system includes a clamping handle, which locks into a recess of the removable lid and is mounted on two clamping rods. The unlocking of the removable lid is carried out by the user in two consecutive movements, first by pivoting the handle upwards, then by tilting the handle and the rods towards the front of the appliance. As soon as the handle is pivoted upwards, a braking system is activated, ensuring mechanical braking of the rotary tool, and the electrical power supply to the electric motor is interrupted.

This locking system gives overall satisfaction, its use being reliable and safe. However, the ergonomics of this locking system can be improved, as its operation requires two successive movements and the handle occupies significant space at the front of the appliance when the removable lid is unlocked, hindering access to the removable lid and the juice tank and cluttering the space located at the front of the appliance.

### SUMMARY

The aim of the present disclosure is then to propose a food preparation appliance with improved ergonomics.

To this end, the present disclosure relates to a food preparation appliance, notably a juicer, comprising at least:
a base,
a tool, mounted on the base,
a removable cover, intended to be mounted on the rest of the appliance to cover the tool,
an electric motor, mounted on the base, rotatable around a main axis and configured to drive the tool, and
a locking system for the removable cover on the base.

According to the present disclosure, the locking system comprises:
an actuation device,
a first lever, arranged inside the base, rotatable relative to the base around a first lever axis, the first lever being configured to be driven in rotation around the first lever axis by the actuation device,
a first hook, configured to be moved by the first lever, and including:
   a lower end, attached to the first lever so as to be rotatable relative to the first lever around a second lever axis parallel to the first lever axis,
   an upper end, and
   an elongated central portion, connecting the lower end to the upper end.

Furthermore, the central portion of the first hook extends through a first opening of the base, being guided by the first opening of the base, so that the first hook is able to:
slide, relative to the base, along its central portion, between a locking position and an unlocking position, and jointly
pivot, relative to the base, around a first pivot axis parallel to the first lever axis and passing through the first opening of the base, between a locking orientation and an unlocking orientation.

Thus, the appliance is operable, by the actuation device driving the first lever in rotation around the first lever axis, between:
a locked configuration, wherein the first hook is in its locking position and in its locking orientation and wherein the upper end of the first hook is in contact with the removable cover, preventing removal of the removable cover, and
an unlocked configuration, wherein the first hook is in its unlocking position and in its unlocking orientation and wherein the upper end of the first hook is spaced from the removable cover, allowing removal of the removable cover.

By means of the present disclosure, the ergonomics of the food preparation appliance are improved. In particular, a single rotational movement of the first lever, caused by acting on the actuation device, is sufficient to unlock the food preparation appliance and allow the removal of the removable cover.

In particular, the first hook is guided on the one hand by its lower end, attached to the first lever, and on the other hand by the first opening of the base, which allows simultaneous sliding and pivoting of the first hook through the opening. Consequently, the rotation of the first lever causes an elliptical movement of the upper end of the first hook, which makes it possible to engage or disengage the upper end of the first hook with the removable cover effectively and reliably. This elliptical movement is particularly advantageous because it simultaneously allows the upper end of the first hook to be moved away from the removable cover along the main axis, thus unlocking the food preparation appliance, and to be spaced from the removable cover perpendicularly to the main axis, thus allowing removal of the removable cover along the vertical axis, without increasing the footprint of the appliance or requiring free space at the front of the appliance.

In other words, unlocking the appliance requires only a single movement acting on the actuation device and, once the appliance is unlocked, the removable cover can be removed with a simple translational movement. Moreover, the first hook does not hinder the disassembly of the removable cover and the juice tank towards the front of the appliance. Furthermore, the elliptical movement of the upper end of the first hook provides an easily perceptible visual indication of the locked or unlocked state of the appliance, while being aesthetically pleasing. The appliance is thus easily usable with one hand.

According to other advantageous aspects of the present disclosure, the food preparation appliance comprises one or more of the following features, taken individually or in any technically possible combination:
The actuation device comprises a rod, rotatable relative to the base around a rod axis, between a locking orientation and an unlocking orientation, and a first connecting rod. The first connecting rod includes a first end, attached to the rod so as to be rotatable relative to the rod around a first connecting rod axis parallel to the rod axis, and a second end, attached to the first lever so as to be rotatable relative to the first lever around a second connecting rod axis parallel to the first lever axis and a third connecting rod axis parallel to the first connecting rod axis. The actuation device is configured so that a rotation of the rod around the rod axis between its locking and unlocking orientations drives the first lever in rotation around the first lever axis by means of the first connecting rod and thus operates the appliance between its locked and unlocked configurations respectively, the appliance being in a locked configuration when the rod is in a locking orientation and the appliance being in an unlocked configuration when the rod is in an unlocking orientation.
The actuation device comprises a handle, attached to the rod and rotatable relative to the base around the rod axis, the handle being configured to drive the rod in rotation around the rod axis between its locking and unlocking orientations.
The rod axis, the first connecting rod axis, and the third connecting rod axis are orthogonal to a height axis. In the locked configuration of the appliance, the rod is located between the first end of the first connecting rod and the second end of the first connecting rod along the height axis, and in the unlocked configuration of the appliance, the first end of the first connecting rod is located between the rod and the second end of the first connecting rod along the height axis. The first end of the first connecting rod is moved downward and

the rod is moved upward along the height axis when the appliance is operated from its unlocked configuration to its locked configuration, and the first end of the first connecting rod is moved upward and the rod is moved downward along the height axis when the appliance is operated from its locked configuration to its unlocked configuration.
In the locked configuration of the appliance, the first connecting rod axis is located on a first side of a plane passing through the rod axis and the third connecting rod axis, in the unlocked configuration of the appliance, the first connecting rod axis is located on a second side of the plane passing through the rod axis and the third connecting rod axis, the second side being opposite the first side, and the appliance passes through an alignment configuration when the appliance is operated between its unlocked and locked configurations, wherein the first connecting rod axis passes through the plane passing through the rod axis and the third connecting rod axis.
The rod is translatable relative to the base along the main axis, between a release position and a braking position, and the release position of the rod is reached when the removable cover is mounted on the rest of the appliance and when the rod is in its locking orientation. The appliance further comprises a braking system, capable of braking a rotation of the electric motor around the main axis, the braking system comprising a braking device, rotationally fixed with the electric motor, and a braking member, attached to the rod so as to be rotatable relative to the rod around the rod axis and fixed in translation relative to the rod along the main axis. A translation of the rod between its release position and its braking position operates the braking member between a release position, reached when the rod is in the release position and wherein the braking member does not cooperate with the braking device so that the braking system does not oppose a rotation of the electric motor around the main axis, and a braking position, reached when the rod is in the braking position and wherein the braking member cooperates with the braking device so that the braking system opposes a rotation of the electric motor around the main axis.
The braking system further includes a return member, exerting a force on the braking member and on the rod along the main axis tending to return the rod to its braking position. When the removable cover is mounted on the rest of the appliance, a rotation of the rod from its unlocking orientation to its locking orientation causes a translation of the rod from its

braking position to its release position, against the force exerted by the return member on the braking member and on the rod, and when the removable cover is not mounted on the rest of the appliance, a rotation of the rod from its unlocking orientation to its locking orientation does not cause a translation of the rod from its braking position to its release position and causes a sliding of the first hook beyond its locking position, under the effect of the force exerted by the return member on the braking member and on the rod.
The braking device is a braking disc, rotationally fixed with the electric motor, the braking member is a braking plate, extending parallel to the braking disc, and in the braking position, the braking plate is in contact with the braking disc to oppose a rotation of the electric motor around the main axis.
The base includes an oblong hole, extending along the main axis, and the rod extends through the oblong hole of the base so that the base does not prevent the translation of the rod along the main axis.
The appliance includes a guiding device, which guides in translation the braking member and the rod relative to the base along the main axis.
A ratio between a first distance, measured between the first lever axis and the first pivot axis, and a length of the first lever, measured between the first lever axis and the second lever axis, is between 1.5 and 4.5, preferably equal to 2.6.
An angular displacement of the first hook around the first pivot axis, between its locking orientation and its unlocking orientation, is greater than or equal to 5°, preferably greater than or equal to 10°.
An angle between the central portion of the first hook and a height axis, measured in a plane perpendicular to the first pivot axis in the unlocking orientation of the first hook, is greater than or equal to 5°, preferably greater than or equal to 15°.
A linear displacement of the first hook along its central portion, between its locking position and its unlocking position, is greater than or equal to 10 mm, preferably greater than or equal to 15 mm.
The appliance further comprises a cut-off device, operable between a power configuration, wherein the electric motor is electrically powered so as to be able to drive the tool, and a cut-off configuration, wherein the electric motor is not electrically powered so as not to be able to drive the tool. The cut-off device is in the power configuration when the appliance is in the locked configuration, the cut-off device is in the cut-off configuration when the appliance is in the unlocked configuration, and the appliance is also operable, by the actuation device driving the first lever in rotation around the first lever axis, in an intermediate configuration, reached between the locked configuration and the unlocked configuration, wherein the upper end of the first hook is in contact with the removable cover, preventing removal of the removable cover and wherein the cut-off device is in the cut-off configuration.
The locking system further comprises a second lever, arranged inside the base, rotatable relative to the base around a third lever axis, the second lever being configured to be driven in rotation around the third lever axis by the actuation device, a second hook, configured to be moved by the second lever, and including a lower end, attached to the second lever and rotatable relative to the second lever around a fourth lever axis parallel to the third lever axis, an upper end, and an elongated central portion, connecting the lower end to the upper end. The central portion of the second hook extends through a second opening of the base, being guided by the second opening of the base, so that the second hook is able to slide, relative to the base, along its central portion, between a locking position and an unlocking position of the second hook relative to the base, and jointly pivot, relative to the base, around a second pivot axis parallel to the fourth lever axis and passing through the second opening of the base, between a locking orientation and an unlocking orientation. The appliance is operated between its locked configuration and its unlocked configuration by the actuation device driving in rotation, in addition to the first lever around the first lever axis, the second lever around the third lever axis. In the locked configuration of the appliance, the second hook is in its locking position and in its locking orientation and the upper end of the second hook is in contact with the removable cover, preventing removal of the removable cover, and in the unlocked configuration of the appliance, the second hook is in its unlocking position and in its unlocking orientation and the upper end of the second hook is spaced from the removable cover, allowing removal of the removable cover.

### BRIEF DESCRIPTION OF THE DRAWINGS

The present disclosure will become clearer upon reading the following description, given solely by way of non-limiting example, and made with reference to the drawings wherein:

FIG. 1 is an exploded perspective view of a food preparation appliance according to a first embodiment of the present disclosure, wherein a base of the appliance, on the one hand, and a removable cover of the appliance, on the other hand, are shown separated from the rest of the appliance.

FIG. 2 is a perspective view of the appliance shown in FIG. 1, wherein the base is shown in transparency.

FIG. 3 is a front view of the appliance shown in FIGS. 1 and 2, the base being shown in transparency, the appliance being in an unlocked configuration.

FIG. 4 is a front view of the appliance shown in FIGS. 1 to 3, the base being shown in transparency, the appliance being in an intermediate configuration.

FIG. 5 is a front view of the appliance shown in FIGS. 1 to 4, the base being shown in transparency, the appliance being in a locked configuration.

FIG. 6 is a side view of the appliance shown in FIGS. 1 to 5, the base being shown in transparency, the appliance being in its unlocked configuration.

FIG. 7 is a side view of the appliance shown in FIGS. 1 to 6, the base being shown in transparency, the appliance being in its intermediate configuration.

FIG. 8 is a side view of the appliance shown in FIGS. 1 to 7, the base being shown in transparency, the appliance being in its locked configuration.

FIG. 9 is a perspective view of a food preparation appliance according to a second embodiment of the present disclosure, which comprises a base of which only a part is shown, the appliance being in an unlocked configuration.

FIG. 10 is a perspective view similar to that shown in FIG. 9, the appliance being in a locked configuration.

FIG. 11 is a schematic representation of a part of the appliance shown in FIGS. 9 and 10, illustrating the positions of a first lever and a first hook of the appliance in the unlocked and locked configurations of the appliance.

### DETAILED DESCRIPTION

In the following description, two axes are orthogonal if they are each parallel to axes intersecting at a right angle. In space, two orthogonal axes can be intersecting or non-intersecting. Two perpendicular axes are orthogonal and intersecting.

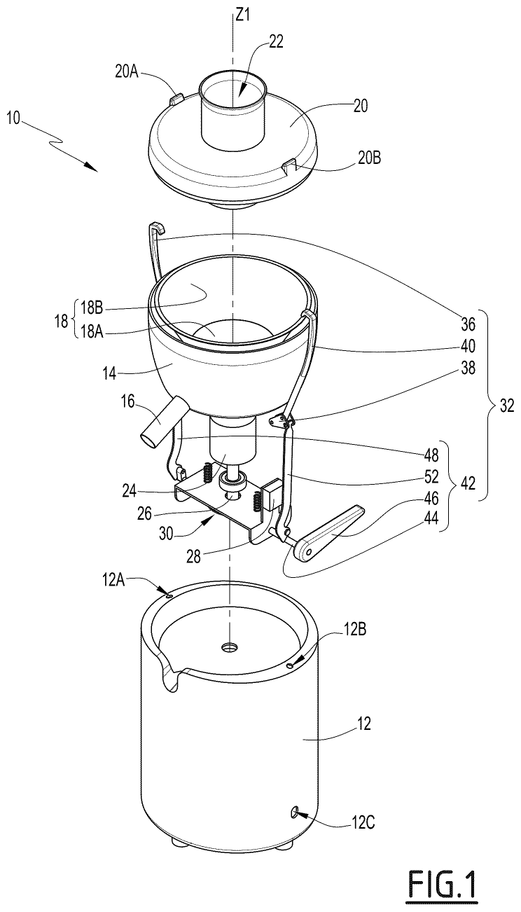

A food preparation appliance 10 according to a first embodiment of the present disclosure is schematically shown in FIGS. 1 to 8. In the example, the appliance 10 is a juicer.

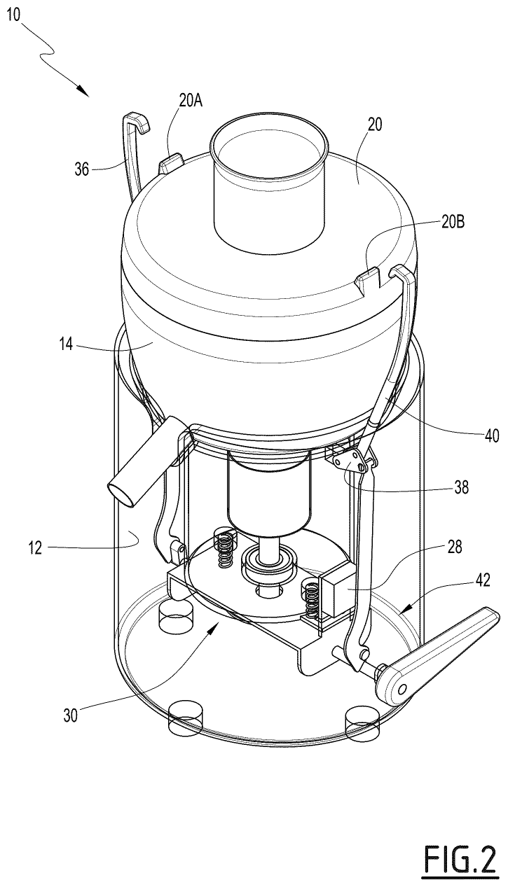

As particularly visible in FIGS. 1 and 2, the appliance 10 includes a base 12, a juice tank 14 mounted on the base 12 and provided with a spout 16, a tool 18, a removable cover 20 wherein an introduction opening 22 for food is arranged, and a reservoir or a bin, not shown and generally arranged opposite the spout 16. The tool 18 is mounted on the base 12. More precisely, the rotary tool 18 is mounted on the juice tank 14, which is itself mounted on the base 12. In the example, the tool 18 is a rotary tool that is rotatable around a main axis Z1 relative to the base 12, which is also a height axis, this height axis being preferably vertical in the normal use configuration of the appliance 10. Here, the rotary tool 18 includes a bottom 18A forming a grater as well as side walls 18B extending from this bottom, which constitute a sieve. The cover 20 is intended to be mounted on the rest of the appliance 10 to cover the rotary tool 18. In practice, the cover 20 is mounted on the juice tank 14. In other words, the cover 20 is mounted on the base 12 by means of the juice tank.

When a food item is introduced into the appliance through the opening 22 of the cover 20 and the rotary tool 18 is in rotation, the contact of the food item against the grater 18A separates the juice of the food item from its solid parts, such as pulp, the juice passing through the sieve 18B to flow into the juice tank 14 and the solid parts being guided by the sieve 18B to the reservoir under the effect of centrifugal force.

To drive the tool 18, the appliance 10 includes an electric motor 24, mounted on the base 12. Here, the electric motor 24 drives the tool 18 by rotating it. For this purpose, the electric motor 24 comprises a motor shaft 26 extending along the main axis Z1. The motor shaft 26 is attached to the rotary tool 18, so that the motor shaft is able to drive the rotary tool in rotation around the main axis Z1. In practice, the electric motor 24 and its motor shaft 26 are arranged inside the base 12, so as not to be visible from the outside of the appliance 10, and the motor shaft 26 extends through the juice tank 14 so as to be able to be attached to the rotary tool 18. Preferably, the electric motor 24 is powered by means of a power cable (not shown).

The appliance 10 includes a cut-off device 28, which is operable between a power configuration, wherein the electric motor 24 is electrically powered so as to be able to drive the rotary tool 18, and a cut-off configuration, wherein the electric motor 24 is not electrically powered so as not to be able to drive the rotary tool 18. In other words, the cut-off device 28 makes it possible to authorize or prohibit the operation of the electric motor 24. Notably, the cut-off device 28 prevents the start-up of the electric motor 24 when its operation would pose a danger to a user, for example, when the cover 20 does not cover the rotary tool 18, as explained below. Thus, the cut-off device 28 has a safety function for the appliance 10.

In the example, the cut-off device 28 is an electrical contact including a body 28A and a probe 28B able to slide relative to the body 28A, the switch between the power and cut-off configurations of the cut-off device being made according to the position of the probe relative to the body.

The appliance 10 includes a braking system 30, capable of braking a rotation of the motor shaft 26 around the main axis Z1, which is also a height axis here. In practice, the braking system 30 includes a braking device 30A, which is fixed to the motor shaft 26, and a braking member 30B, which is translatable relative to the base 12 and thus relative to the braking device 30A, along the main axis Z1.

The braking member 30B is translatable along the main axis Z1 between a release position, wherein the braking member 30B does not cooperate with the braking device 30A, so that the braking system 30 does not oppose a rotation of the motor shaft 26 around the main axis Z1, and a braking position, wherein the braking member 30B cooperates with the braking device 30A so that the braking system 30 opposes a rotation of the motor shaft 26 around the main axis Z1. In other words, when the electric motor 24 is in operation and the braking member 30B is displaced to the braking position, then the braking system 30 brakes, then stops, the rotation of the motor shaft 26.

Advantageously, the braking member 30B is guided in translation along the main axis Z1, relative to the base 12, by an unrepresented guiding device. Preferably, the guiding device also opposes a rotation of the braking member 30B around the main axis Z1. The guiding device thus facilitates the translation of the braking member 30B and prevents other movements of the braking member 30B. Furthermore, by guiding the braking member 30B, the guiding device also makes it possible to guide the rod 44 in its translational movement along the main axis Z1.

In the example, the braking device 30A is a braking disc, rotationally fixed with the motor shaft 26, and the braking member 30B is a braking plate, preferably metallic, which comes into contact with the braking disc 30A when the braking plate 30B is in the braking position. The braking disc 30A and the braking plate 30B extend parallel to each other, preferably perpendicular to the main axis Z1. Advantageously, the braking disc 30A is equipped with a braking lining 30C, which extends from the braking disc 30A towards the braking plate 30B, ensuring better braking between the braking disc and the braking plate.

Advantageously, the braking system 30 includes a return member 30D, which exerts a force on the braking member 30B along the main axis Z1 tending to bring the braking member closer to the braking device 30A. In other words, the return member 30D tends to return the braking member 30B to the braking position. In the example, the return member 30D comprises two compression springs extending along the main axis Z1 between the braking member 30B and the base 12.

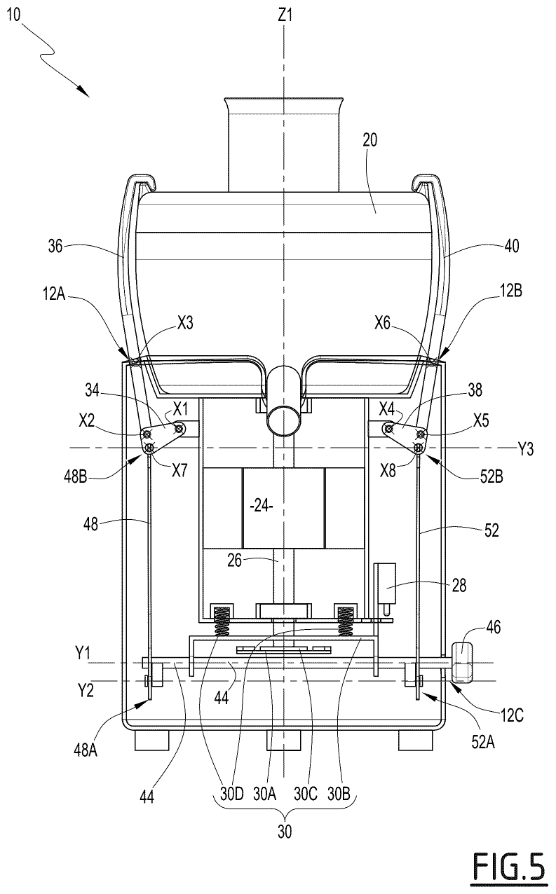

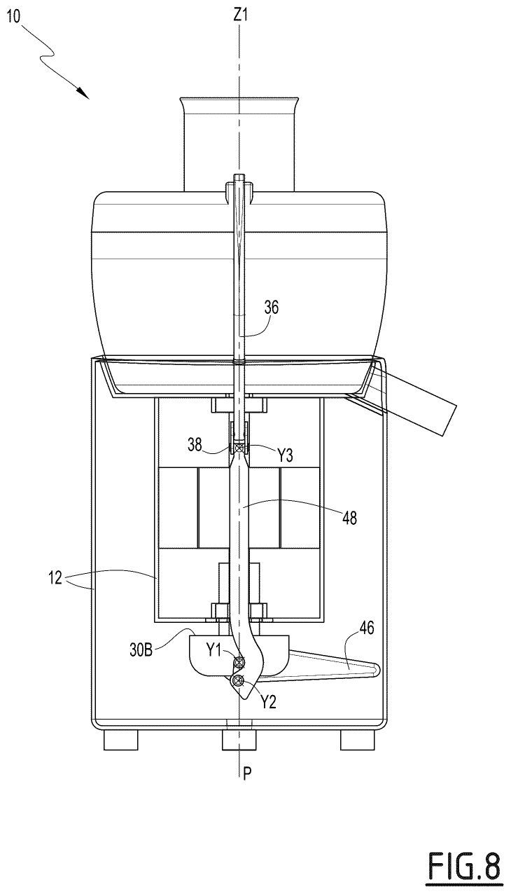

The appliance 10 is operable between a locked configuration, illustrated in FIGS. 5 and 8, and an unlocked configuration, illustrated in FIGS. 2, 3, and 6.

In the locked configuration, the cover 20 is held on the rest of the appliance 10, in other words, the removal of the cover is prevented, so that the appliance is able to be operated safely, without the risk that a user can access the rotary tool 18 while the rotary tool is rotating around the main axis Z1. Furthermore, in the locked configuration, the braking member 30B is in the release position so that the braking system 30 does not brake a rotation of the motor shaft 26 around the main axis Z1 and the cut-off device 28 is in the power configuration, so that the electric motor 24 is electrically powered.

In the unlocked configuration, the cover 20 can be removed from the rest of the appliance 10, so that access to the rotary tool 18 is possible. Furthermore, in the locked configuration, the braking member 30B is in the braking position so that the braking system 30 brakes a rotation of the motor shaft 26 around the main axis Z1 and prevents a rotation of the motor shaft, and the cut-off device 28 is in the cut-off configuration, so that the electric motor 24 is not electrically powered. By means of the cut-off device 28 and the braking system 30, the appliance 10 is secured by two distinct means when it is unlocked.

The appliance 10 includes a locking system 32 designed to keep the removable cover 20 securely on the rest of the appliance 10 when the appliance is in the locked configuration, without preventing the removal of the cover when the appliance is in the unlocked configuration. The locking system 32 includes a first lever 34 and a first hook 36.

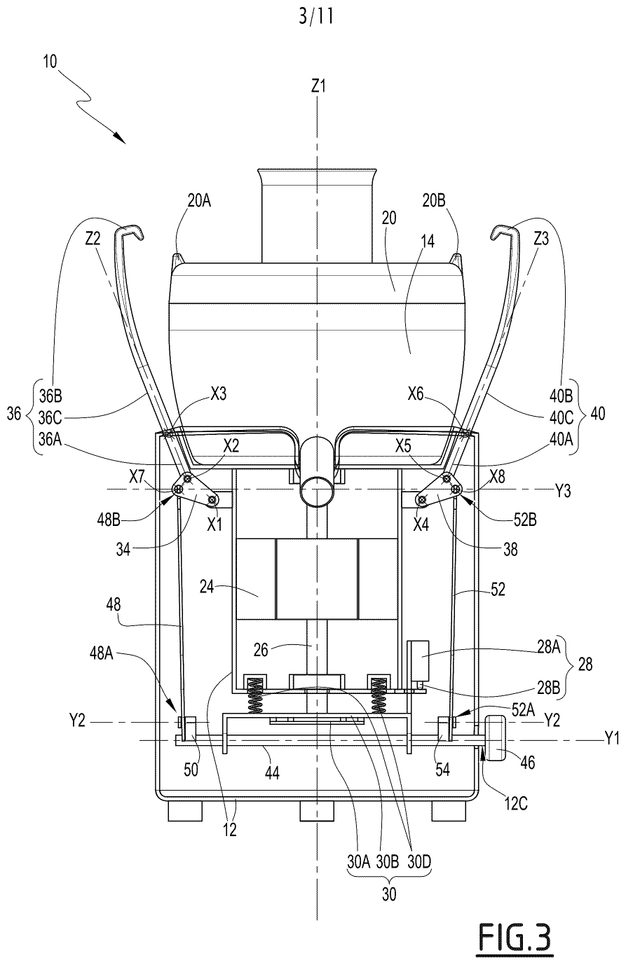

The operation of the locking system 32 is particularly visible in FIGS. 3, 4, and 5.

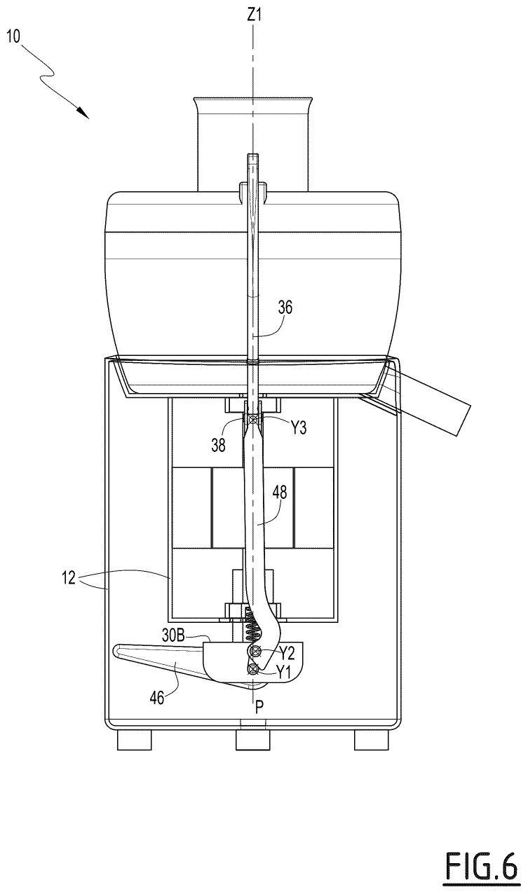

The first lever 34 is arranged in the base 12 and rotatable relative to the base around a first lever axis X1, which is non-parallel to the main axis Z1, between a locking orientation and an unlocking orientation. In other words, the first lever 34 is pivotally mounted relative to the base 12 around the first lever axis X1. Here, the first lever axis X1 is orthogonal to the main axis Z1. Furthermore, the first lever axis X1 is fixed relative to the base 12. By “in the base,” it is understood that the first lever 34 is located inside the base 12, i.e., in an internal volume of the appliance 10 delimited by the base 12, as clearly visible in FIGS. 6 to 8. Thus, the first lever 34 cannot be directly manipulated by a user of the appliance 10 from outside the base 12.

The first hook 36 includes a lower end 36A, an upper end 36B, and an elongated central portion 36C connecting the lower end 36A to the upper end 36B.

The lower end 36A is attached to the first lever 34 so as to be rotatable relative to the first lever 34 around a second lever axis X2 parallel to the first lever axis X1. In other words, the first hook 36 is able to pivot relative to the first lever 34 around the second lever axis X2. The lower end 36A is advantageously arranged inside the base 12. Thus, the first hook 36 is moved by the first lever 34. More precisely, the lower end 36A being attached to the first lever at the second lever axis X2, it is displaced by the first lever 34 in a rotational movement around the first lever axis X1: when the first lever is displaced between its locking and unlocking orientations, the lower end 36A follows an arc of a circle around the first lever axis X1. It is noted that the second lever axis X2 is movable relative to the base 12.

In the example, the first lever 34 is formed by two identical and parallel plates, connected by two shafts extending respectively along the first lever axis X1 and along the second lever axis X2. Other designs are possible for the first lever, such as a monobloc design.

The upper end 36B is designed to cooperate with the cover 20 to hold the cover mounted on the rest of the appliance 10 when the appliance is in the locked configuration. More precisely, the upper end 36B is designed to mechanically cooperate with the cover 20, notably by shape complementarity, to hold the cover mounted on the rest of the appliance 10.

In the example, for this purpose, the upper end 36B has a hook shape that cooperates with a first lug 20A of the cover 20 when the appliance 10 is in the locked configuration. The upper end 36B is arranged outside the base 12.

The central portion 36C connects the lower end 36A to the upper end 36B and extends through a first opening 12A of the base 12. In other words, the central portion 36C passes through the base 12 and the first opening 12A is a hole formed in the base 12. Advantageously, a seal is provided in the opening 12A, through which the central portion 36C extends, to ensure the sealing of the base 12. The seal is, for example, an elastomer seal.

It is thus understood that the lower end 36A of the first hook is arranged inside the

base 12, while the upper end 36B is arranged outside the base 12. Thus, the first opening 12A of the base 12 passes through the base, connecting the inside of the base to the outside of the base. Moreover, the hook 36, and more particularly the central portion 36C, extends through the first opening 12A of the base 12 by passing through the base, i.e., the hook 36 extends from the inside of the base to the outside of the base. In this way, the lower end 36A, like the first lever 34, are arranged inside the base 12 and are inaccessible from outside the base, notably by a user of the appliance 10. Furthermore, the seal provided in the opening 12A prevents the infiltration of liquids and solids from outside the base 12 to the inside of the base through the first opening 12A, thereby prolonging the life of the appliance 10, notably by protecting the electric motor 24.

In the example, the elongated central portion 36C is cylindrical, so that it is straight and extends along a first hook axis Z2. In a non-represented variant of the present disclosure, the central portion 36C has a different shape and/or is not straight. For example, the central portion 36C is bent or curved.

Since the central portion 36C extends through the first opening 12A of the base 12, the first opening of the base guides the central portion when the first hook 36 is moved by the first lever 34. More precisely, the guiding of the central portion 36C by the first opening 12A of the base 12 makes the first hook 36 able to slide, relative to the base 12, along its central portion 36C, between a locking position and an unlocking position, and jointly, pivot, relative to the base, around a first pivot axis X3 parallel to the first lever axis X1 and the second lever axis X2 and passing through the first opening 12A of the base 12, between a locking orientation and an unlocking orientation. It is understood that, in the example, the sliding of the first hook 36 is carried out along the first hook axis Z2. It is noted that the first pivot axis X3 is fixed relative to the base 12. It is thus understood that it is precisely because the central portion 36C passes through the base 12 by extending in the first opening 12A, i.e., extends from the inside to the outside of the base, that the central portion 36C is guided by the first opening 12A of the base so that the first hook 36 presents a joint sliding and pivoting movement.

It is noted that the guiding of the central portion 36C by the first opening 12A forms a mechanical connection between the first hook 36 and the base 12 of the sphere/cylinder type connection, also commonly referred to as an annular linear connection. This guiding is favored by the presence of the seal in the opening 12A.

In practice, the first opening 12A has dimensions slightly larger than the dimensions of the central portion 36C, so as to allow the pivoting of the first hook 36 around the pivot axis X3. In other words, a functional clearance is provided between the central portion 36C and the first opening 12A, allowing the displacement of the central portion 36C to pivot around the pivot axis X3.

In practice, the guiding of the central portion 36C by the first opening 12A does not alone prevent the pivoting of the first hook 36 around an axis perpendicular to the first pivot axis X3, nor the rotation of the first hook on itself, in the example, around the first hook axis Z2, but these movements are prevented because the lower end 36A of the first hook 36 is attached to the first lever 34 and is only movable relative to the first lever 34 in rotation around the second lever axis X2.

The locking position and the locking orientation of the first hook 36 are jointly reached when the first lever 34 is in the locking orientation and the unlocking position and the unlocking orientation of the first hook 36 are jointly reached when the first lever 34 is in the unlocking orientation.

In the locked configuration of the appliance 10, the first lever 34 is in the locking orientation and the first hook 36 is in the locking position and in the locking orientation. In the unlocked configuration of the appliance 10, the first lever 34 is in the unlocking orientation and the first hook 36 is in the unlocking position and in the unlocking orientation.

When the first lever 34 is operated between its locking and unlocking orientations, the rotational movement of the lower end 36A of the first hook 36 around the first lever axis X1, in association with the guiding of the central portion 36C by the first opening 12A of the base 12, leads the upper end 36B of the first hook 36 to move in an elliptical movement, which makes it possible to engage or disengage the upper end of the first hook with the first lug 20A of the cover 20 effectively and reliably.

Advantageously, but optionally, the locking system 32 also includes a second lever 38 and a second hook 40, which function respectively like the first lever 34 and the first hook 36, symmetrically.

Thus, the second lever 38 is rotatable relative to the base 12 around a third lever axis X4 and the second hook 40 includes a lower end 40A attached to the second lever 38 and rotatable relative to the second lever around a fourth lever axis X5 parallel to the third lever axis X4, an upper end 40B designed to cooperate with the cover 20, having in the example a hook shape that cooperates with a second lug 20B of the cover 20, and an elongated central portion 40C that connects the lower end 40A to the upper end 40B and extends through a second opening 12B of the base 12 along a second hook axis Z3. The second hook 40 is guided by the second opening 12B of the base 12 so as to be able to slide along its central portion 40C between a locking position and an unlocking position, and to pivot around a second pivot axis X6 parallel to the fourth lever axis X5 and the first pivot axis X3 and passing through the second opening of the base, similarly to the first hook 36. Like that of the first hook 36, the upper end 40B of the second hook 40 displaces in an elliptical movement. In the example, the third lever axis X4 is parallel to the first lever axis X1. In other words, in the example, the first lever 34 is parallel to the second lever 38. Advantageously, in the example, the first lever 34 and the second lever 38 extend in the same plane, which is parallel to the main axis Z1 and which, preferably, passes through the main axis Z1. It is noted that the fourth lever axis X5 is movable relative to the base 12. Just like the first hook 36, the lower end 40A of the second hook is arranged inside the base 12, while the upper end 40B is arranged outside the base 12. Thus, the second opening 12B of the base 12 passes through the base, connecting the inside of the base to the outside of the base. Moreover, the second hook 40, and more particularly the central portion 40C, extends through the second opening 12B of the base 12 by passing through the base, i.e., the second hook 40 extends from the inside of the base to the outside of the base. In this way, the lower end 40A, like the second lever 38, are arranged inside the base 12 and are inaccessible from outside the base, notably by a user of the appliance 10. Furthermore, a seal provided in the opening 12B and through which the central portion 40C extends, preferably in elastomer, prevents the infiltration of liquids and solids from outside the base 12 to the inside of the base through the second opening 12B and also favors the guiding of the central portion 40C in the second opening 12B.

The locking position and the locking orientation of the second hook 40 are jointly reached when the second lever 38 is in the locking orientation and the unlocking position and the unlocking orientation of the second hook are jointly reached when the second lever is in the unlocking orientation.

In the locked configuration of the appliance 10, the second lever 38 is in the locking orientation and the second hook 40 is in the locking position and in the locking orientation. In the unlocked configuration of the appliance 10, the second lever 38 is in the unlocking orientation and the second hook 40 is in the unlocking position and in the unlocking orientation.

Thus, the removable cover 20 is held on the rest of the appliance 10 by the two hooks 36, 40, which cooperate respectively with the two lugs 20A, 20B.

To drive the first lever 34 and the second lever 38 in rotation, respectively around the first lever axis X1 and the third lever axis X4, between their locking and unlocking orientations, the locking system 32 includes an actuation device 42.

The operation of the actuation device 42 is particularly visible in FIGS. 6, 7, and 8.

In the example, the actuation device 42 includes a rod 44, which is rotatable relative to the base 12 around a rod axis Y1, between a locking orientation and an unlocking orientation. In the example, the rod axis Y1 is orthogonal to the main axis Z1, which improves the operation of the actuation device 42 but is not mandatory: the rod axis Y1 can also be oblique with the main axis Z1, i.e., non-parallel to the main axis Z1. Moreover, in the example, the rod axis Y1 is also orthogonal to the first lever axis X1 and the third lever axis X4, which improves the operation of the actuation device 42 but is not mandatory. Furthermore, in the example, the rod axis Y1 is perpendicular to the main axis Z1, which improves the operation of the actuation device 42 but is not mandatory.

Here, the actuation device 42 includes a handle 46, attached to the rod 44 and rotatable relative to the base 12 around the rod axis Y1. The handle 46 is designed to be operated by a user, so as to allow the user to drive the rod 44 in rotation around the rod axis Y1 between its locking and unlocking orientations. Advantageously, one hand is sufficient to act on the handle 46. Furthermore, the handle 46 allows the user to have a sufficient lever arm to effectively act on the rod 44, against the force exerted by the return member 30D.

The actuation device 42 also includes a first connecting rod 48, designed to drive the first lever 34 in rotation from the rotation of the rod 44. The first connecting rod 48 includes a first end 48A, attached to the rod 44 so as to be rotatable relative to the rod around a first connecting rod axis Y2 parallel to the rod axis Y1. It is noted that the first connecting rod axis Y2 is movable relative to the base 12.

The rod 44 and the first connecting rod 48 are arranged so that a rotation of the rod 44 around the rod axis Y1 causes a displacement of the first end 48A of the first connecting rod 48, in an arc of a circle movement around the rod axis Y1. In other words, the first end 48A of the first connecting rod 48 rotates around the rod 44 when the rod is in rotation around the rod axis Y1.

In the example, to obtain this arc of a circle displacement, the first end 48A of the first connecting rod 48 is attached to a first link rod 50 of the actuation device 42, which extends from the rod 44 perpendicularly to the rod axis Y1, here being monobloc with the rod. The first end 48A of the first connecting rod 48 is able to pivot relative to the first link rod 50 around the first connecting rod axis Y2. The first connecting rod 48 is thus attached to the first link rod 50 at the first connecting rod axis Y2.

The first connecting rod 48 also includes a second end 48B, attached to the first lever 34 so as to be rotatable relative to the first lever around a second connecting rod axis X7 parallel to the first lever axis X1 and a third connecting rod axis Y3 parallel to the first connecting rod axis Y2. It is noted that the third connecting rod axis Y3 is movable relative to the base 12.

Since the first connecting rod 48 is attached to the first lever 34 and the rod 44, a rotational movement of the rod 44 causes a pivoting of the first connecting rod, in a plane perpendicular to the rod axis Y1, and a translation of the first connecting rod, caused by the arc of a circle movement of its first end 48A.

In other words, when the first connecting rod 48 is displaced by the rod 44, the first connecting rod drives the first lever 34 in rotation around the first lever axis X1, by imposing a displacement of the first lever 34 at the second connecting rod axis X7.

Furthermore, the fact that the second end 48B of the first connecting rod 48 is rotatable around the third connecting rod axis Y3 relative to the first lever 34 allows the first connecting rod to pivot in a plane perpendicular to the rod axis Y1 without causing a movement of the first lever 34 in this plane. In practice, the mobility of the second end 48B of the first connecting rod 48 around the third connecting rod axis Y3 is obtained by means of the functional clearance present between the second end 48B of the first connecting rod 48 and the first lever 34.

Advantageously, the actuation device 42 also includes a second connecting rod 52, designed to drive the second lever 38 in rotation from the rotation of the rod 44 and which functions like the first connecting rod 48. Thus, the second connecting rod 52 includes a first end 52A attached to the rod 44 by means of a second link rod 54 being rotatable relative to the second link rod 54 and relative to the rod 44 around the first connecting rod axis Y2. The second connecting rod 52 also includes a second end 52B, attached to the second lever 38 so as to be rotatable relative to the second lever around a fourth connecting rod axis X8 parallel to the third lever axis X4 and the third connecting rod axis Y3 parallel to the first connecting rod axis Y2.

The actuation device 42 is configured so that a rotation of the rod 44 around the rod axis Y1 between its locking and unlocking orientations drives the first lever 34 in rotation around the first lever axis X1, by means of the first connecting rod 48, and drives the second lever 38 in rotation around the third lever axis X4, by means of the second connecting rod 52, and thus operates the appliance 10 between its locked and unlocked configurations respectively, the appliance being in a locked configuration when the rod 44 is in a locking orientation and the appliance being in an unlocked configuration when the rod is in an unlocking orientation.

Thus, the actuation of the handle 46 causes the displacement of the first hook 36 and the second hook 40 and thus operates the appliance 10 between its locked and unlocked configurations.

The actuation device 42 is therefore particularly advantageous for effectively transforming a rotation of the handle 46 into a rotation of the two levers 34, 38 and thus into a movement of the two hooks 36, 40. By means of the locking system 32 and the actuation device 42, a rotation of the handle 46 is sufficient to actuate the two hooks 36, 40 and thus operate the appliance 10 between its locked and unlocked configurations. The appliance 10 is thus particularly easy to lock and unlock by a user, including with one hand.

Particularly advantageously, the braking system 30 is operated by the locking system 32, in particular by the actuation device 42. More precisely, the braking member 30B is displaced in translation relative to the base 12, along the main axis Z1, between its release and braking positions, by the actuation device 42.

To this end, the braking member 30B is attached to the rod 44 so as to be rotatable relative to the rod around the rod axis Y1 and fixed in translation relative to the rod along the main axis Z1. In other words, the braking member 30B is operated between its release and braking positions by the rod 44.

Furthermore, the rod 44 is translatable relative to the base 12 along the main axis Z1, between a release position and a braking position. The release position of the braking member 30B is reached when the rod 44 is in the release position and the braking position of the braking member 30B is reached when the rod is in the braking position. Thus, the rod axis Y1 is movable relative to the base 12.

In practice, the release position of the rod 44 is reached when the cover 20 is mounted on the rest of the appliance 10 and when the rod 44 is in its locking orientation. When the cover 20 is not mounted on the rest of the appliance 10 and/or when the rod 44 is in its unlocking orientation, then the rod is in its braking position.

Advantageously, the rod 44 extends through an oblong hole 12C of the base 12, the oblong hole 12C extending along the main axis Z1, so that the rod 44 is able to pass through the base 12 without the base 12 preventing the translation of the rod 44 along the main axis Z1.

It is thus understood that the rod 44 connects the inside of the base 12 to the outside of the base, making it possible to act on the levers 36, 38 arranged inside the base 12 from outside the base, in the example by means of the handle 46. This design is particularly advantageous for improving the durability of the appliance 10 while facilitating its use. Indeed, only the handle 46, the upper ends 36B, 40B of the hooks 36, 40, and a part of the central portions 36C, 40C of the hooks 36, 40 are located outside the base 12, so that only these parts are accessible to a user of the appliance 10. Conversely, all other elements of the locking system 32 and in particular of the actuation device 42 are located inside the base 12 and are therefore not accessible from outside the base 12 for a user of the appliance 10: these other elements are therefore protected, which improves the life of the appliance 10, and are not visible, which improves the aesthetics of the appliance. In particular, the elliptical movement of the upper ends of the two hooks, which is caused by the simple rotation of the handle 46, without the entire system of the actuation device and the locking system allowing the transformation of the rotation of the handle into an elliptical movement of these ends being visible, is aesthetically pleasing.

The rod 44 being fixed in translation relative to the braking member 30B, the force exerted by the return member 30D on the braking member 30B tends to return the rod to its braking position. In other words, the braking position of the rod 44 is a rest position, or a position occupied by the rod in the absence of other forces exerted on the rod or the braking member 30B.

Thus, when the cover 20 is not mounted on the rest of the appliance 10, a rotation of the rod 44 from its unlocking orientation to its locking orientation does not cause a translation of the rod from its braking position to its release position, but rather causes a sliding of the first hook 36 and the second hook 40 beyond their locking position, under the effect of the force exerted by the return member 30D on the braking member 30B and on the rod 44. Indeed, in the absence of the cover 20, nothing prevents the first and second hooks 36, 40 from sliding beyond their locking position and the force exerted by the return member 30D prevents the displacement of the rod 44 from its braking position to its release position. Consequently, the rotation of the rod causes a movement of the first ends 48A, 52A of the first and second connecting rods 48, 52 in an arc of a circle around the rod axis Y1, moving the first and second connecting rods 48, 52 away from the first and second openings 12A, 12B of the base 12, which causes a rotation of the first and second levers 34, 38 around the first and third lever axes X1, X4 beyond their locking orientation and thus a sliding of the first and second hooks 36, 40 beyond their locking position.

On the contrary, when the cover 20 is mounted on the rest of the appliance 10, a rotation of the rod 44 from its unlocking orientation to its locking orientation causes a translation of the rod 44 from its braking position to its release position, against the force exerted by the return member 30D on the braking member 30B and on the rod 44. Indeed, when the cover 20 is mounted on the rest of the appliance 10, the first and second hooks 36, 40 are in contact with the first and second lugs 20A, 20B, so that the first and second hooks 36, 40 cannot slide beyond their locking position. Consequently, the rotation of the rod causes a movement of the first ends 48A, 52A of the first and second connecting rods 48, 52 in an arc of a circle around the rod axis Y1, but since the first and second connecting rods 48, 52 cannot be moved away from the first and second openings 12A, 12B of the base 12 due to the contact of the first and second hooks 36, 40 against the first and second lugs 20A, 20B, this movement of the first ends 48A, 52A of the first and second connecting rods 48, 52 causes a displacement of the rod 44 from its braking position to its release position, against the force exerted by the return member 30D. In other words, the contact of the first and second hooks 36, 40 against the first and second lugs 20A, 20B makes it possible to overcome the force exerted by the return member 30D on the braking member 30B and on the rod 44.

Thus, the linked operation of the braking system 30 and the locking system 32, obtained because the actuation device 42 operates the braking system 30, ensures that the braking member 30B is able to reach its release position only when the cover 20 is mounted on the rest of the appliance 10 and when the first and second hooks 36, 40 are in their locking position and in their locking orientation. In other words, the braking system 30 allows the operation of the electric motor 24 only when the cover 20 is mounted on the rest of the appliance 10 and locked by the locking system 32, preventing any start-up of the electric motor 24 when the rotary tool 18 is accessible by a user.

It is also noted that in the locked configuration of the appliance 10, the rod 44 is located between the first end 48A of the first connecting rod 48 and the second end 48B of the first connecting rod 48 along the main axis Z1, and that the rod 44 is located between the first end 52A of the second connecting rod 52 and the second end 52B of the second connecting rod 52 along the main axis Z1. Conversely, in the unlocked configuration of the appliance 10, the first end 48A of the first connecting rod 48 is located between the rod 44 and the second end 48B of the first connecting rod 48 along the main axis Z1, and that the first end 52A of the second connecting rod 52 is located between the rod 44 and the second end 52B of the second connecting rod 52 along the main axis Z1. These positions are obtained by means of the arc of a circle movement centered on the rod axis Y1 that the first end 48A of the first connecting rod 48 and the first end 52A of the second connecting rod 52 follow. Thus, the first end 48A of the first connecting rod 48 and the first end 52A of the second connecting rod 52 are displaced downward and the rod 44 is moved upward along the main axis Z1, i.e., along a vertical axis, when the appliance 10 is operated from its unlocked configuration to its locked configuration. Conversely, the first end 48A of the first connecting rod 48 and the first end 52A of the second connecting rod 52 are displaced upward and the rod 44 is displaced downward along the main axis Z1, i.e., along a vertical axis, when the appliance 10 is operated from its locked configuration to its unlocked configuration.

These movements, obtained in particular by means of the contact of the first and second hooks 36, 40 against the first and second lugs 20A, 20B of the cover 20 and by means of the force exerted by the return member 30D on the braking member 30B, make it

possible to simultaneously operate the first and second levers 34, 38 to lock and unlock the first and second hooks 36, 40, and operate the braking system 30 to engage or release the braking member 30B from the braking device 30A.

Particularly advantageously, the locking orientation and the unlocking orientation of the rod 44 are chosen so that in the locked configuration of the appliance 10, the first connecting rod axis Y2 is located on a first side of a plane P passing through the rod axis Y1 and the third connecting rod axis Y3, while in the unlocked configuration of the appliance 10, the first connecting rod axis Y2 is located on a second side of the plane P, the second side being opposite the first side. Thus, the appliance 10 passes through an alignment configuration when the appliance is operated between its unlocked and locked configurations, wherein the first connecting rod axis Y2 passes through the plane P, i.e., wherein the first connecting rod axis Y2, the rod axis Y1, and the third connecting rod axis Y3 are aligned.

Furthermore, in the alignment configuration of the appliance, the first connecting rod axis Y2, the rod axis Y1, and the third connecting rod axis Y3 are aligned along the main axis Z1, i.e., they are aligned parallel to the direction along which the return member 30D exerts a force on the braking member 30B tending to bring the braking member closer to the braking device 30A. Moreover, it is in the alignment configuration of the appliance that the force exerted by the return member 30D on the braking member 30B is maximal. Thus, in the example, it is in the alignment configuration of the appliance that the compression of the two compression springs is maximal. Therefore, the fact that the first connecting rod axis Y2, the rod axis Y1, and the third connecting rod axis Y3 are not aligned in the locked configuration of the appliance 10 is particularly advantageous because it makes the locked configuration of the appliance 10 stable. Indeed, it is necessary to exert a force against the return force of the return member 30D to move from the locked configuration of the appliance 10 to the alignment configuration of the appliance, preventing accidental unlocking of the appliance. The actuation device 42 thus acts as a mechanical toggle device.

Advantageously, the cut-off device 28 is mounted so as to be operated between its power configuration and its cut-off configuration by the rod 44, so that the cut-off device is in the power configuration when the rod 44 is in the release position and so that the cut-off device is in the cut-off configuration when the rod 44 is in the braking position. Thus, the configuration of the cut-off device 28 depends on the position of the rod 44 along the main axis Z1.

In the example, the body 28A is mounted on the braking member 30B so as to be fixed in translation relative to the braking member and movable in translation relative to the base 12, along the main axis Z1, and the probe 28B is mounted on the base 12 so as to be fixed relative to the base. Thus, when the braking member 30B is displaced by the rod 44 between its release and braking positions, the probe 28B is moved relative to the body 28A, switching the cut-off device 28 between its power and cut-off configurations.

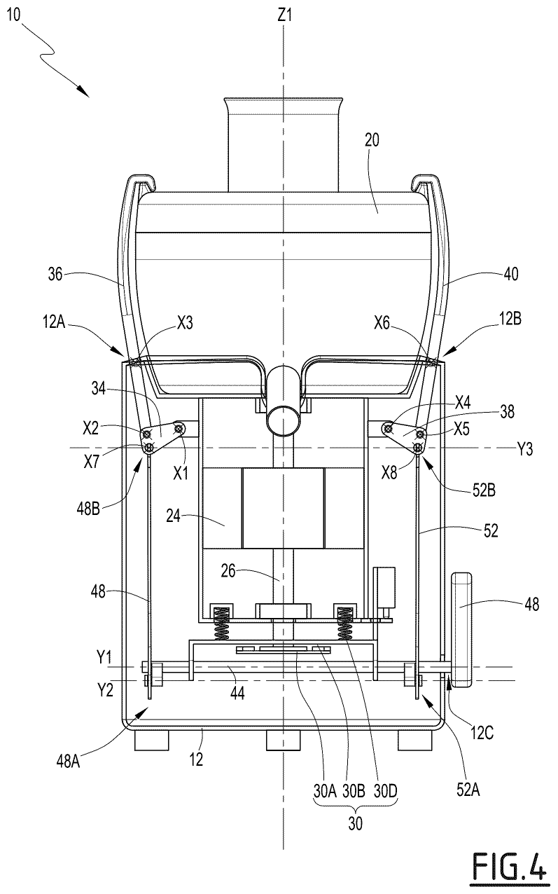

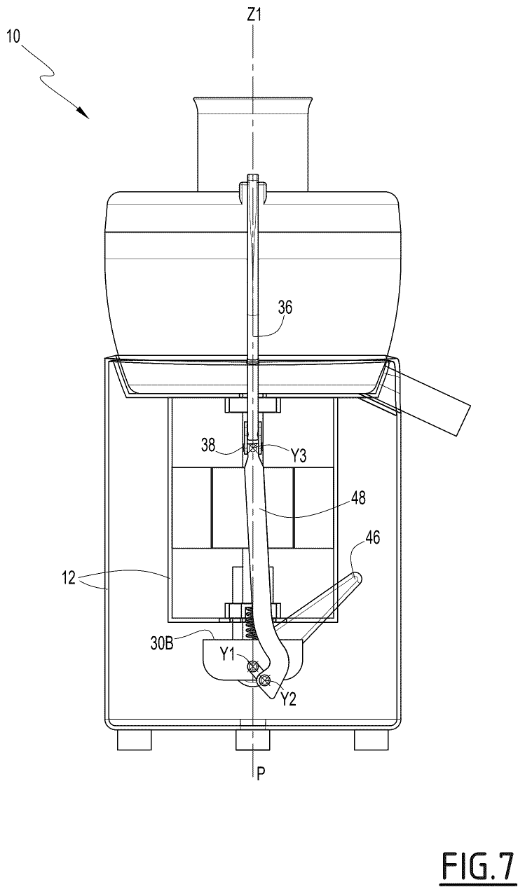

Advantageously, the appliance 10 is also operable in an intermediate configuration illustrated in FIGS. 4 and 7, reached between the locked configuration and the unlocked configuration, wherein the upper end 36B of the first hook 36 and the upper end 40B of the second hook 40 are in contact with the cover 20, preventing removal of the cover, and wherein the cut-off device 28 is in the cut-off configuration. Furthermore, in the intermediate configuration, the braking system 30 does not oppose the rotation of the electric motor 24, i.e., the braking member 30B is in the release position.

Thus, when the appliance 10 moves from its locked configuration to its unlocked configuration, it passes through its intermediate configuration. In the locked configuration, the braking member 30B is in the release position and the cut-off device 28 is in the power configuration, so that the electric motor 24 can operate and the motor shaft 26 and the rotary tool 18 can be driven in rotation around the main axis Z1. In the intermediate configuration of the appliance 10, the braking member 30B is still in the release position but the cut-off device 28 is in the cut-off configuration, so that the electric motor 24 is not powered, but the motor shaft 26 and the rotary tool 18 can still rotate around the main axis Z1, since their rotation is not braked by the braking system 30. In the unlocked configuration of the appliance 10, the braking member 30B is in the braking position and the cut-off device 28 is in the cut-off configuration, so that the electric motor 24 is not powered and so that the rotation of the motor shaft 26 and the rotary tool 18 around the main axis Z1 is prevented by the braking system 30.

This opening sequence is particularly advantageous for increasing the life of the appliance 10 because it prevents the braking of the motor shaft 26 by the braking system 30 when the cut-off device 30 is in the power configuration, i.e., when the electric motor 24 is likely to operate. In other words, the rotation of the motor shaft 26 can only be braked when the electric motor 24 is stopped, thus avoiding applying braking to the electric motor when it is operating, which could damage the electric motor.

Furthermore, and as shown in FIGS. 4 and 5 and FIGS. 7 and 8, the first and second levers 34, 38 reach their locking orientation as soon as the appliance 10 is in the intermediate configuration. This is, in particular, due to the arrangement of the rod 44, the first and second connecting rods 48, 52, and the first and second levers 34, 38. Thus, in the intermediate configuration, the first and second hooks 36, 40 are in their locking position and in their locking orientation. In other words, the movement of the first and second hooks 36, 40 takes place between the unlocked and intermediate configurations of the appliance 10 and the first and second hooks 36, 40 remain in their locking position and in their locking orientation between the intermediate configuration and the locked configuration of the appliance 10. Moreover, it is noted, notably in FIGS. 3 to 5, that the compression of the return member 30D, here of the two springs 30D, mainly takes place between the intermediate configuration and the locked configuration of the appliance 10, notably by means of the arrangement of the connecting rod 44, the braking member 30B, the first and second connecting rods 48, 52, and the first and second link rod 50, 54. However, it is during the compression of the springs 30D that the force exerted by the user on the handle 46 is maximum. Thus, when the forces exerted on the handle are maximum, the first and second hooks 36, 40 are not in motion, so that the forces exerted on the first and second levers 36, 38 are minimum, reducing the wear on the first and second levers and thus increasing the longevity of the appliance 10. Even in the absence of movement of the first and second hooks 36, 40, the compression of the return member 30D between the intermediate and locked configurations of the appliance 10 nevertheless causes a compression of the first and second hooks 36, 40 against the removable cover 20, in a clamping effort ensuring a secure closure of the appliance 10.

Moreover, when the appliance 10 is operated from its locked configuration to its unlocked configuration, it is noted that the electrical cut-off of the electric motor 24 occurs by means of the cut-off device 28 before the first and second hooks 36, 38 begin to be displaced from their locking orientation and position to their unlocking orientation and position, which ensures a stop of the electric motor before the removal of the removable cover 20 is possible. Therefore, even in the event of rapid manipulation of the handle 46 by a user, the rotary tool 18 cannot be reached before being braked. The appliance 10 according to the present disclosure is therefore particularly safe to use, while being simple to lock and unlock by means of the locking system 32.

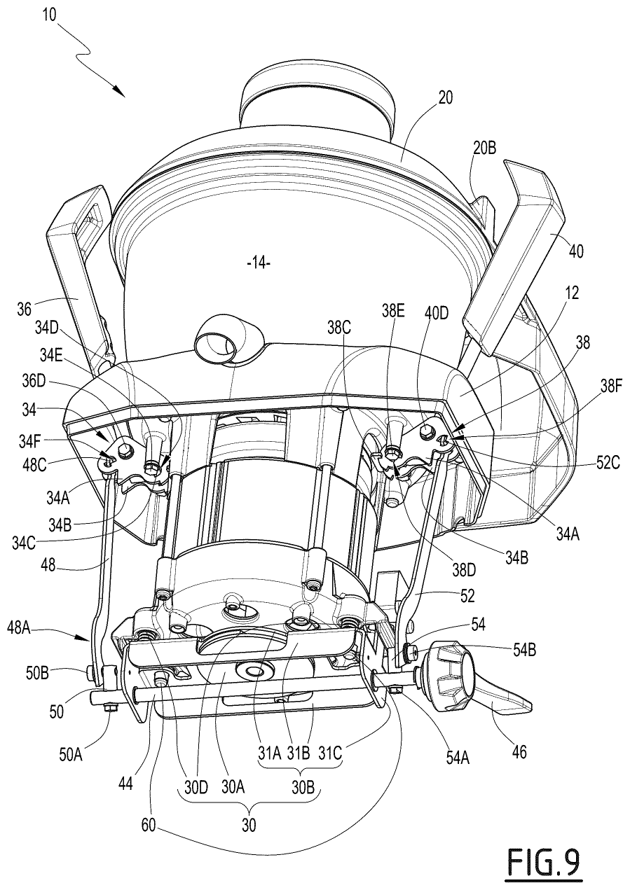

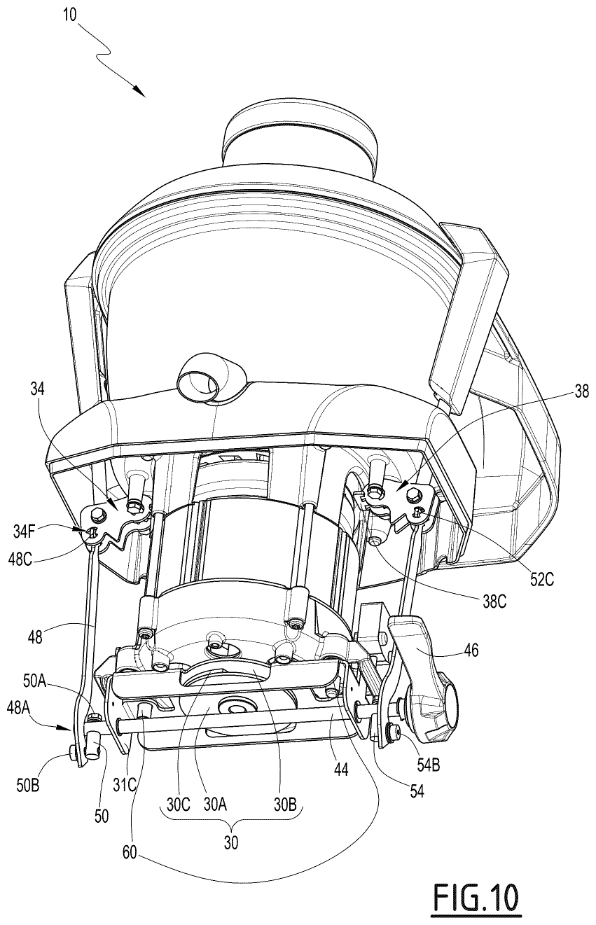

A food preparation appliance 10 according to a second embodiment of the present disclosure is shown in FIGS. 9 and 10. In the second embodiment, elements analogous to those of the first embodiment bear the same references and function in the same way. In the following, the differences between the first and second embodiments are mainly described.

Furthermore, if a component is mentioned in the description of the second embodiment without being shown in FIGS. 9 and 10, it corresponds to the same element shown in FIGS. 1 to 8 for the first embodiment. The appliance 10 of the second embodiment is shown in the unlocked configuration in FIG. 9 and in the locked configuration in FIG. 10.

In practice, the food preparation appliance 10 of the second embodiment has an identical operation to that of the first embodiment but is less expensive to manufacture than that of the first embodiment.

In particular, the locking system 32 of the food preparation appliance 10 of the second embodiment is particularly inexpensive to manufacture, while being reliable and robust.

Notably, the first lever 34 includes a first plate 34A and a second plate 34B, which extend parallel to each other and parallel to the first lever axis X1. Furthermore, the first lever 34 is rotatable relative to the base 12 at the first lever axis X1 by means of a pivot plate 34C, which is mounted between the first plate 34A and the second plate 34B and which extends through openings 34D of the first plate and the second plate, the openings 34D being traversed by the first lever axis X1. The pivot plate 34C is fixed to the base 12 using screws 34E, which keep the pivot plate 34C immobile relative to the base. This design makes it possible to obtain a reliable and robust connection of the first lever 34A on the base 12.

Moreover, the lower end 36A of the first hook 36 is attached to the first lever 34 by means of a screw 36D extending along the second lever axis X2, which makes it possible to effectively articulate the first hook 36 relative to the first lever 34 at the second lever axis X2.

Furthermore, the first plate 34A and the second plate 34B have openings 34F, which are traversed by the second connecting rod axis X7. The second end 48B of the first connecting rod 48 is arranged between the first plate 34A and the second plate 34B of the first lever 34 and has a “T” shape, with two arms 48C extending along the second connecting rod axis X7 so as to extend through the openings 34F of the first plate and the second plate. The cooperation of the two arms 48C with the openings 34F allows the first connecting rod 48 to pivot relative to the first lever 34 around the second connecting rod axis X7 while preventing other movements of the first connecting rod relative to the first lever.

The design of the second lever 38, the second hook 40, and the second connecting rod 52 are advantageously identical to those of the first lever 34 and the first connecting rod 48. Thus, the second lever 38 includes a first plate 38A and a second plate 38B having openings 38D and 38F, and a pivot plate 38C fixed to the base 12 by a screw 38E. The lower end 40A of the second hook 40 is attached to the second lever 38 by means of a screw 40D extending along the fourth lever axis X5. The second end 52B of the second connecting rod 52 has a “T” shape with two arms 52C extending along the fourth connecting rod axis X8.

Advantageously, the first plates 34A and 38A, the second plates 34B and 48B, the pivot plates 34C and 38C, the first and second connecting rods 48, 52 are manufactured by laser cutting, making it possible to obtain particularly inexpensive parts.

Advantageously, and as visible in FIGS. 9 and 10, the openings 34D, 34F, 38D, and 38F are not circular but have the shape of two fans, or two circular disk sectors, joined by their vertices. Thus, the openings 34D, 34F, 38D, and 38F limit the angular displacement respectively of the pivot plate 34C, the two arms 48C of the first connecting rod 48, the pivot plate 34C, and the two arms 52C of the second connecting rod 52.

In the second embodiment, the braking member 30B includes a braking plate 31A, which extends parallel to the braking device 30A and perpendicular to the main axis Z1, two side walls 31B, which extend from the braking plate 31A perpendicular to the braking plate 31A and make it possible to stiffen the braking member 30B, and two edges 31C, which extend from the braking plate 31A perpendicular to the rod axis Y1 being traversed by the rod 44. Thus, the two edges 31C ensure the attachment between the braking member 30B and the rod 44, preventing a translation of the braking member relative to the rod but allowing a rotation of the braking member relative to the rod around the rod axis Y1. The braking member 30B is advantageously manufactured from a flat sheet cut and then bent, making it possible to obtain a particularly inexpensive part, while ensuring a reliable connection between the braking member 30B and the rod 44.

In the second embodiment, the first link rod 50 attaching the first end 48A of the first connecting rod 48 to the rod 44 is not monobloc with the rod 44, but is fixed to the rod using a fixing member 50A, preferably a screw. Furthermore, the first link rod 50 is connected to the first end 48A of the first connecting rod 48 by means of a fixing member 50B, here a shoulder screw, which makes it possible to secure the first end 48A to the link rod 50 without preventing a rotation of the first end 48A relative to the link rod 50 around the first connecting rod axis Y2. The design of the second link rod 54 is identical, the latter being fixed to the rod 44 using a fixing member 54A and to the second connecting rod using a fixing member 54B. This design makes the actuation device 42 particularly inexpensive to produce because the cost of manufacturing the link rods 50, 54 and their attachment to the connecting rods 48, 52 and the rod 44 is low.

In the second embodiment, the return member 30D includes four compression springs extending along the main axis Z1 between the braking member 30B and the base 12, of which only two are visible in FIGS. 9 and 10. The use of four compression springs improves the guiding of the braking member 30B in translation along the main axis Z1, compared to the two compression springs used in the first embodiment. Advantageously, the braking plate 31A is substantially rectangular and the four compression springs are arranged at the four corners of the braking plate 31A.

Advantageously, in the second embodiment, the braking member 30B is guided in translation along the main axis Z1, relative to the base 12, by a guiding device 60. Preferably, the guiding device 60 also opposes a rotation of the braking member 30B around the main axis Z1. The guiding device 60 thus facilitates the translation of the braking member 30B and prevents other movements of the braking member 30B. Furthermore, by guiding the braking member 30B, the guiding device also makes it possible to guide the rod 44 in its translational movement along the main axis Z1.

In the example of the second embodiment, the guiding device 60 includes two guiding axes 60, which are fixed to the base 12 and which each extend parallel to the main axis Z1 by passing through the braking member 30B, more precisely by passing through two openings of the braking member 30B. Thus, the two guiding axes 60 do not oppose a translation of the braking member 30B along the main axis Z1, but prevent a translation of the braking member 30B perpendicular to the main axis Z1. Furthermore, the two guiding axes 60 are arranged on either side of the motor shaft 26, in a plane perpendicular to the main axis Z1, thus effectively preventing a rotation of the braking member 30B around the main axis Z1. Thus, when the braking member 30B is in the braking position, the rotation of the braking device 30A is not likely to cause the braking member 30B to rotate around the main axis Z1, and the braking of the braking device 30A and thus of the motor shaft 26 is then effective.

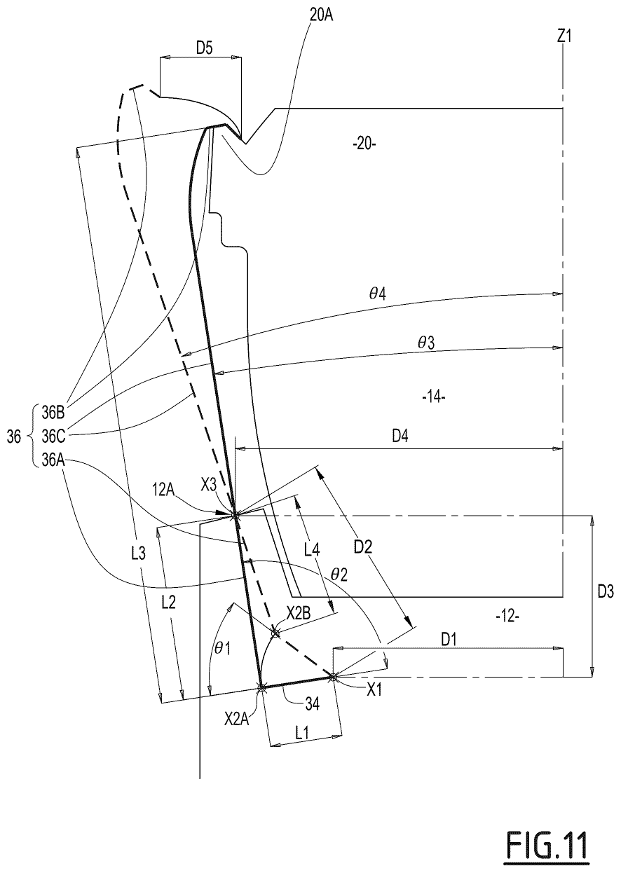

We now describe, with reference to FIG. 11, certain geometric and kinematic characteristics of the appliance 10 of the second embodiment shown in FIGS. 9 and 10. In practice, the geometric and kinematic characteristics described in connection with FIG. 11 are also applicable to the appliance 10 of the first embodiment of FIGS. 1 to 8.

In the following, reference is made only to the geometric and kinematic characteristics of the first lever 34 and the first hook 36 of the appliance 10 of the second embodiment, but what is described is also applicable to the second lever 38 and the second hook 40.

In particular, in FIG. 11, the base 12, the juice tank 14, and the removable cover 20 are schematically represented by their outer envelope. The first lug 20A of the cover 20 and the first opening 12A of the base 12, as well as the first pivot axis X3, are notably represented.

Furthermore, the first lever 34 and the first hook 36 are schematically represented.

More precisely, the first lever 34 is only illustrated by its profile between the first lever axis X1 and the second lever axis X2. The profile of the first lever 34 is illustrated simultaneously in its locking and unlocking orientations, by a solid line in its locking orientation and by a dotted line in its unlocking orientation, the second lever axis X2 being referenced X2A in the locking orientation of the first lever 34 and being referenced X2B in the unlocking orientation of the first lever 34.

Similarly, the first hook 36 is only illustrated by means of its profile, represented by a solid line in its locking orientation and position and by a dotted line in its unlocking orientation and position.

It is thus noted that, as previously specified, the upper end 36B of the first hook 36 follows an elliptical trajectory between the unlocked and locked configurations of the appliance 10, i.e., an arc of an ellipse, this arc of an ellipse being highlighted in FIG. 11.

The first pivot axis X3, fixed relative to the base 12, is also shown in FIG. 11.

Preferably, the first lever axis X1 is arranged at a distance D1 from the main axis Z1, i.e., from the motor shaft 26, measured perpendicularly to the main axis Z1, between 60 mm and 90 mm, for example equal to 75 mm.

Preferably, a length L1 of the first lever 34, measured between the first lever axis X1 and the second lever axis X2 in a plane perpendicular to the first lever axis X1, is between 18 mm and 29 mm, for example equal to 23.5 mm.

Preferably, an angular displacement θ1 of the first lever 34 around the first lever axis X1, between its locking orientation and its unlocking orientation, is greater than 30°, preferably still between 30° and 60°, preferably still between 40° and 50°, for example equal to 45.5°.

Preferably, a distance D2, measured between the first lever axis X1 and the first pivot axis X3 in a plane perpendicular to the first lever axis X1, is between 45 mm and 78 mm, preferably still between 56 mm and 67 mm, for example equal to 61.4 mm.

Advantageously, a ratio between the distance D2 and the length L1 is between 1.5 and 4.5, preferably still between 2 and 3, for example equal to 2.6. Such a ratio makes it possible, from the rotation of the first lever 34 around the first lever axis X1, to obtain a sliding and pivoting of the first hook f36 allowing both an effective holding of the cover 20 in the locked configuration of the appliance 10 and a sufficient distance between the first hook and the cover in the unlocked configuration of the appliance, allowing a simple removal of the cover.

Furthermore, a distance D3, measured between the first lever axis X1 and the first pivot axis X3 along the main axis Z1, is between 38.5 mm and 66.7 mm, preferably still between 45 mm and 59 mm, for example equal to 52.5 mm.

Moreover, a distance D4, measured between the first pivot axis X3 and the main axis Z1, measured perpendicularly to the main axis Z1, is between 80 mm and 130 mm, preferably still between 95 mm and 117 mm, for example equal to 106.5 mm.

Preferably, when the first lever 34 is in its locking orientation, an angle θ2 formed between the lower end 36A of the first hook 36 and the first lever 34, more precisely between the lower end 36A of the first hook 36 and an axis connecting the first lever axis X1 to the second lever axis X2, is between 75° and 115°, preferably between 85° and 95°, for example equal to 90°.

Preferably, a length L3 of the first hook 36, measured between its lower end 36A and its upper end 36B in a plane perpendicular to the first pivot axis X3, more precisely measured parallel to the central portion 36C of the first hook 36, is between 150 mm and 215 mm, preferably between 175 mm and 190 mm, for example equal to 182.8 mm.

Preferably, when the first lever 34 is in its locking orientation and when the first hook 36 is in its locking orientation and in its locking position, an internal length L2 of the first hook 36, measured between its lower end 36A and the first pivot axis X3 in a plane perpendicular to the first pivot axis X3, more precisely measured parallel to the central portion 36C of the first hook 36, is between 50 mm and 65 mm, preferably between 55 mm and 60 mm, for example equal to 56.7 mm.

Preferably, when the first lever 34 is in its locking orientation and when the first hook 36 is in its locking orientation and in its locking position, an angle θ3 between the central portion 36C of the first hook 36 and the main axis Z1, measured in a plane perpendicular to the first pivot axis X3, is less than 13°, preferably still between 5° and 13°, preferably still between 7° and 11°, for example equal to 9°.

Preferably, when the first lever 34 is in its unlocking orientation and when the first hook 36 is in its unlocking orientation and in its unlocking position, an internal length L4 of the first hook 36, measured between its lower end 36A and the first pivot axis X3 in a plane perpendicular to the first pivot axis X3, more precisely measured parallel to the central portion 36C of the first hook 36, is between 34 mm and 47 mm, preferably between 38 mm and 43 mm, for example equal to 40.5 mm.

Thus, a linear displacement of the first hook 36 along its central part 36C, between its locking position and its unlocking position, is greater than or equal to 10 mm, preferably greater than or equal to 15 mm, in the example equal to 16.2 mm. In other words, the first hook 36 slides in the first opening 12A over a length preferably greater than or equal to 10 mm, preferably still greater than or equal to 15 mm, in the example equal to 16.2 mm.

Preferably, when the first lever 34 is in its unlocking orientation and when the first hook 36 is in its unlocking orientation and in its unlocking position, an angle θ4 between the central portion 36C of the first hook 36 and the main axis Z1, measured in a plane perpendicular to the first pivot axis X3, is greater than or equal to 5°, preferably still between 5° and 25°, preferably still greater than or equal to 10°, preferably still between 10° and 23°, for example equal to 19°.

Thus, an angular displacement of the first hook 36 around the first pivot axis X3, between its locking orientation and its unlocking orientation, i.e., a difference between the locking orientation and the unlocking orientation of the first hook, is greater than or equal to 5°, preferably greater than or equal to 10°, in the example equal to 10°.

By means of the angular displacement of the first hook 36 between its locking orientation and its unlocking orientation, and to a lesser extent by means of the linear displacement of the first hook between its locking position and its unlocking position, the first hook 36 is sufficiently distant from the removable cover 20 to allow a user to easily remove the cover from the rest of the appliance 10 when the appliance is in the unlocked configuration.

In particular, a distance D5 measured between the upper end 36B of the first hook 36 in its unlocking orientation and in its unlocking position and the upper end 36B of the first hook 36 in its locking orientation and in its locking position, measured perpendicularly to the main axis Z1, is advantageously between 10 mm and 40 mm, preferably between 20 mm and 30 mm, in the example equal to 26.4 mm. Thus, the upper end 36B of the first hook 36 is sufficiently distant from the rest of the appliance 10, perpendicularly to the main axis Z1, so as not to hinder the removal of the cover 20 from the rest of the appliance, in a translational movement along the main axis Z1.

The specific dimensions specified above allow for an efficient movement of the first hook 36 to maintain the cover 20 in the locked configuration of the appliance 10 and to not hinder the removal of the cover in the unlocked configuration of the appliance 10.

In an unrepresented variant of the present disclosure, the upper ends 36B, 40B of the first and second hooks 36, 40 cooperate with the cover 20 through means different from the first and second lugs 20A, 20B. For example, the cover 20 has two recesses, or notches, wherein lugs of the upper ends 36B, 40B are received when the appliance is in the locked configuration. The present disclosure is not limited to these examples.

In an unrepresented variant of the present disclosure, the cover 20 does not comprise

a second lug, the locking system 32 does not comprise a second lever or a second hook, and the actuation device 42 does not include the second connecting rod. In such a variant, the cover 20 is held locked only by the first hook 36, or is held locked by another locking device, such as, for example, a hook keeping the cover 20 fixed relative to the juice bowl 14.

In an unrepresented variant of the present disclosure, the rod 44 extends along a rod axis parallel to the first lever axis X1. In such a variant, the second connecting rod axis X7 and the third connecting rod axis Y3 are coincident. Such a variant is particularly advantageous for simplifying the design of the appliance 10 when it only includes one lever and one hook.

In an unrepresented variant of the present disclosure, the locking system comprises a different actuation device to operate the first and second levers 34, 38. For example, the first and second levers 34, 38 are directly operated by a handle that does not operate the braking system 30. In such a variant, the braking system 30 can be operated separately from the locking system 32.

In an unrepresented variant of the present disclosure, the culinary preparation appliance 10 is a device of a type other than a juicer, such as, for example, a citrus press, a blender, a chopper, an ice crusher, a cheese grater, a vegetable cutter, or a multifunction robot.

In an unrepresented variant of the present disclosure, the tool 18 is not a rotary tool, but, for example, a tool mobile in translation relative to the base 12, or mobile relative to the base in a movement combining one or more translations and/or one or more rotations relative to the base. For example, the tool is mobile in translation along the main axis Z1, like a press, such as a citrus press. In such a variant, the electric motor 24 drives the tool 18 by means of a transmission adapted to transform the rotational movement of the electric motor 24 into a movement adapted to the tool 18.

In an unrepresented variant of the present disclosure, the electric motor 24 does not extend along a vertical axis. In other words, the main axis Z1, which corresponds to the rotation axis of the electric motor 24, is not necessarily vertical, this orientation being however preferred when the tool 18 is a rotary tool mobile in rotation around the vertical axis to simplify the design of the appliance 10. It is noted that, in the description of the embodiments shown in FIGS. 1 to 11, reference is made indistinctly to the main axis Z1 corresponding to the rotation axis of the electric motor 24 and to a height axis, because the main axis Z1 is vertical, i.e., it corresponds to a height axis, in these embodiments. It is thus understood that, in variants where the main axis Z1 is not vertical, certain characteristics described above in relation to the main axis Z1 are then understood in relation to a height axis, in this case a vertical axis. For example, for the operation of the actuation device 42, the orthogonality of the rod axis Y1, the first connecting rod axis Y2, and the third connecting rod axis Y3 with a height axis is advantageous, but the orthogonality of these axes with the main axis Z1 when the main axis Z1 is not a height axis does not provide particular advantages. Conversely, it is advantageous that the braking member 30B is mobile in translation relative to the base 12 along the main axis Z1 corresponding to the rotation axis of the electric motor 24, but the fact that the braking member 30B is mobile in translation relative to a height axis does not bring particular advantage. It is however particularly advantageous that the rotation axis of the electric motor 24 is a height axis, notably vertical, as this facilitates the design of the appliance 10, notably by simplifying and optimizing the interactions between the braking system 30 and the actuation device 42.

Any feature described for one embodiment or variant in the foregoing can be implemented for the other embodiments and variants described above, as long as technically feasible.

What is claimed is:

1. A culinary preparation appliance comprising:
a base;
a tool mounted on the base;
a removable cover configured to be mounted on the rest of the culinary preparation appliance to cover the tool;
an electric motor mounted on the base, the electric motor mobile in rotation around a main axis and configured to drive the tool; and
a locking system of the removable cover on the base,
wherein the locking system comprises:
an actuation device;
a first lever arranged inside the base, the first lever mobile in rotation relative to the base around a first lever axis, the first lever configured to be driven in rotation around the first lever axis by the actuation device; and
a first hook configured to be set in motion by the first lever, the first hook comprising:
a lower end attached to the first lever so as to be mobile in rotation relative to the first lever around a second lever axis parallel to the first lever axis;
an upper end; and
an elongated central portion connecting the lower end to the upper end,
wherein the elongated central portion of the first hook extends through a first opening of the base, the elongated central portion of the first hook being guided by the first opening of the base, so that the first hook is configured to:
slide relative to the base along its central portion between a locking position and an unlocking position; and
jointly pivot relative to the base around a first pivot axis parallel to the first lever axis and passing through the first opening of the base between a locking orientation and an unlocking orientation, and
wherein the culinary preparation appliance is configured to operate by the actuation device driving in rotation the first lever around the first lever axis between:
a locked configuration, wherein the first hook is in its locking position and in its locking orientation and wherein the upper end of the first hook is in contact with the removable cover, preventing removal of the removable cover; and
an unlocked configuration, wherein the first hook is in its unlocking position and in its unlocking orientation and wherein the upper end of the first hook is spaced from the removable cover, allowing removal of the removable cover.

2. The culinary preparation appliance according to claim 1, wherein the actuation device comprises:
a rod mobile in rotation relative to the base around a rod axis between a locking orientation and an unlocking orientation; and
a first connecting rod comprising:
a first end attached to the rod so as to be mobile in rotation relative to the rod around a first connecting rod axis parallel to the rod axis; and
a second end attached to the first lever so as to be mobile in rotation relative to the first lever around a second connecting rod axis parallel to the first lever axis and a third connecting rod axis parallel to the first connecting rod axis,
wherein the actuation device is configured so that a rotation of the rod around the rod axis between its locking and unlocking orientations drives in rotation the first lever around the first lever axis by the first connecting rod and thus operates the culinary preparation appliance between its locked and unlocked configurations respectively, the culinary preparation appliance being in the locked configuration when the rod is in the locking orientation and the culinary preparation appliance being in the unlocked configuration when the rod is in the unlocking orientation.

3. The culinary preparation appliance according to claim 2, wherein the actuation device comprises a handle attached to the rod and mobile in rotation relative to the base around the rod axis, the handle configured to drive in rotation the rod around the rod axis between its locking and unlocking orientations.

4. The culinary preparation appliance according to claim 2, wherein the rod axis, the first connecting rod axis, and the third connecting rod axis are orthogonal to a height axis, wherein:
in the locked configuration of the culinary preparation appliance, the rod is located between the first end of the first connecting rod and the second end of the first connecting rod along the height axis; and
in the unlocked configuration of the culinary preparation appliance, the first end of the first connecting rod is located between the rod and the second end of the first connecting rod along the height axis,
wherein the first end of the first connecting rod is moved downward and the rod being moved upward along the height axis when the culinary preparation appliance is operated from its unlocked configuration to its locked configuration, and
wherein the first end of the first connecting rod is displaced upward and the rod being displaced downward along the height axis when the culinary preparation appliance is operated from its locked configuration to its unlocked configuration.

5. The culinary preparation appliance according to claim 4, wherein in the locked configuration of the culinary preparation appliance, the first connecting rod axis is located on a first side of a plane passing through the rod axis and through the third connecting rod axis, wherein in the unlocked configuration of the culinary preparation appliance, the first connecting rod axis is located on a second side of the plane passing through the rod axis and through the third connecting rod axis, the second side being opposite to the first side, and wherein the culinary preparation appliance passes through an alignment configuration when the culinary preparation appliance is operated between its unlocked configuration and its locked configuration, wherein the first connecting rod axis passes through the plane passing through the rod axis and through the third connecting rod axis.

6. The culinary preparation appliance according to claim 4, wherein the height axis corresponds to the main axis.

7. The culinary preparation appliance according to claim 2, wherein the rod is mobile in translation relative to the base along the main axis between a release position and a braking position,
wherein the release position of the rod is reached when the removable cover is mounted on the rest of the culinary preparation appliance and when the rod is in its locking orientation,
wherein the culinary preparation appliance further comprises a braking system configured to brake a rotation of the electric motor around the main axis, the braking system comprising:
a braking device integral in rotation with the electric motor; and
a braking member attached to the rod so as to be mobile in rotation relative to the rod around the rod axis and fixed in translation relative to the rod along the main axis, and
wherein a translation of the rod between its release position and its braking position operates the braking member between:
a release position reached when the rod is in the release position and wherein the braking member does not cooperate with the braking device so that the braking system does not oppose a rotation of the electric motor around the main axis; and
a braking position reached when the rod is in the braking position and wherein the braking member cooperates with the braking device so that the braking system opposes a rotation of the electric motor around the main axis.

8. The culinary preparation appliance according to claim 7, wherein the braking system further comprises a return member exerting a force on the braking member and on the rod along the main axis tending to return the rod to its braking position,
wherein when the removable cover is mounted on the rest of the culinary preparation appliance, a rotation of the rod from its unlocking orientation to its locking orientation causes a translation of the rod from its braking position to its release position against the force exerted by the return member on the braking member and on the rod, and
wherein when the removable cover is not mounted on the rest of the culinary preparation appliance, a rotation of the rod from its unlocking orientation to its locking orientation does not cause a translation of the rod from its braking position to its release position and causes a sliding of the first hook beyond its locking position under an effect of the force exerted by the return member on the braking member and on the rod.

9. The culinary preparation appliance according to claim 7, wherein the braking device is a braking disc integral in rotation with the electric motor, the braking member is a braking plate extending parallel to the braking disc, and in the braking position, the braking plate is in contact with the braking disc to oppose a rotation of the electric motor around the main axis.

10. The culinary preparation appliance according to claim 7, wherein the base comprises an oblong hole extending along the main axis, and the rod extends through the oblong hole of the base so that the base does not prevent the translation of the rod along the main axis.

11. The culinary preparation appliance according to claim 7, further comprising a guiding device, which guides in translation the braking member and the rod relative to the base along the main axis.

12. The culinary preparation appliance according to claim 1, wherein a ratio between a first distance measured between the first lever axis and the first pivot axis and a length of the first lever measured between the first lever axis and the second lever axis is between 1.5 and 4.5.

13. The culinary preparation appliance according to claim 1, wherein an angular displacement of the first hook around the first pivot axis between its locking orientation and its unlocking orientation is greater than or equal to 5°.

14. The culinary preparation appliance according to claim 13, wherein the angular displacement of the first hook around the first pivot axis between its locking orientation and its unlocking orientation is greater than or equal to 10°.

15. The culinary preparation appliance according to claim 1, wherein an angle between the elongated central portion of the first hook and a height axis measured in a plane perpendicular to the first pivot axis in the unlocking orientation of the first hook is greater than or equal to 5°.

16. The culinary preparation appliance according to claim 15, wherein the angle between the elongated central portion of the first hook and a height axis measured in a plane perpendicular to the first pivot axis in the unlocking orientation of the first hook is greater than or equal to 15°.

17. The culinary preparation appliance according to claim 1, wherein a linear displacement of the first hook along its central part between its locking position and its unlocking position is greater than or equal to 10 mm.

18. The culinary preparation appliance according to claim 17, wherein the linear displacement of the first hook along its central part between its locking position and its unlocking position is greater than or equal to 15 mm.

19. The culinary preparation appliance according to claim 1, further comprising a cut-off device operable between:
a power supply configuration, wherein the electric motor is electrically powered so as to be able to drive the tool; and
a cut-off configuration, wherein the electric motor is not electrically powered so as not to be able to drive the tool,
wherein the cut-off device is in the power supply configuration when the culinary preparation appliance is in the locked configuration,
wherein the cut-off device is in the cut-off configuration when the culinary preparation appliance is in the unlocked configuration, and
wherein the culinary preparation appliance is also operable by the actuation device driving in rotation the first lever around the first lever axis in an intermediate configuration reached between the locked configuration and the unlocked configuration, wherein the upper end of the first hook is in contact with the removable cover, preventing removal of the removable cover, and wherein the cut-off device is in the cut-off configuration.

20. The culinary preparation appliance according to claim 1, wherein the locking system further comprises:
a second lever arranged inside the base, the second lever mobile in rotation relative to the base around a third lever axis, the second lever configured to be driven in rotation around the third lever axis by the actuation device; and
a second hook configured to be set in motion by the second lever the second hook comprising:
a lower end attached to the second lever and mobile in rotation relative to the second lever around a fourth lever axis parallel to the third lever axis;
an upper end; and
an elongated central portion connecting the lower end to the upper end,
wherein the elongated central portion of the second hook extends through a second opening of the base being guided by the second opening of the base, so that the second hook is configured to:
slide relative to the base along its central portion between a locking position and an unlocking position of the second hook relative to the base; and
jointly pivot relative to the base around a second pivot axis parallel to the fourth lever axis and passing through the second opening of the base between a locking orientation and an unlocking orientation,
wherein the culinary preparation appliance is operated between its locked configuration and its unlocked configuration by the actuation device driving in rotation, in addition to the first lever around the first lever axis and the second lever around the third lever axis,
wherein in the locked configuration of the culinary preparation appliance, the second hook is in its locking position and in its locking orientation and the upper end of the second hook is in contact with the removable cover, preventing removal of the removable cover, and
wherein in the unlocked configuration of the culinary preparation appliance, the second hook is in its unlocking position and in its unlocking orientation and the upper end of the second hook is spaced from the removable cover, allowing removal of the removable cover.
